(19) United States
(12) Patent Application Publication
(10) Pub. No.: US 2001/0049634 A1
(43) Pub. Date: Dec. 6, 2001

(54) System and method for conducting electronic commerce in the metals industry

(76) Inventor: Patrick Stewart, Sewickley, PA (US)

Correspondence Address: BUCHANAN INGERSOLL, P.C., 301 GRANT STREET, 20TH FLOOR, PITTSBURGH, PA, 15219

(21) Appl. No.: 09/799,375

(22) Filed: Mar. 5, 2001

Related U.S. Application Data
(60) Provisional application No. 60/187,281, filed on Mar. 6, 2000.

(51) Int. Cl. G06F 17/60

(52) U.S. Cl. 705/26

(57) ABSTRACT

An on-line interactive network community for the integrated purchase and sale of metals, particularly steel, is disclosed. The community provides an on-line supply chain of steel from raw products producers through the eventual end user customer for steel products. Buyer members and seller members after they have been qualified to participate and are assigned their unique member identifications, and sale of products, such as steel coils, by means of the electronic system. A complete legally binding contract is created between the buyer and seller, including all the terms and conditions necessary to transfer the product from buyer to seller. Buyer members are given the option to purchase steel products from an on-line product catalog by either an auction mechanism or a fixed-price product guide. By entering certain information, such as the form, grade, gauge or width of a steel coil, for example, the buyer member is given a listing of qualifying products, identified by seller member, from which the buyer can choose. Once selected, the buyer member's financial account can be automatically checked to determine if funds are available to make the purchase, assuring the seller member of prompt payment. Additionally, a carrier may be contracted to transport the purchased product from the seller location to the buyer location.

This patent application is closely related to our pending provisional patent application Serial No. 60/187,281, filed on Mar. 6, 2000.

### BACKGROUND OF THE INVENTION

1. Field of the Invention

The present invention relates generally to the interactive sale and purchase of products and/or commodities within a common marketplace, and more particularly to the establishment of an on-line electronic commerce system for sale, purchase, financing and transportation of steel products.

2. Description of the Prior Art

The purchase and sale of products within the metals industry, and particularly within the steel industry, involves numerous levels of buyers and sellers directly interacting in order for buyers to be able to purchase the particular type of steel product that is required. For example, producers of steel, such as an integrated steel mill or mini-mill, typically provide a finished steel product, such as hot and/or cold rolled steel products, to a buyer, whether it be a product manufacturer or intermediate processor. The buyer typically transforms that product into an end product which is then resold to either another intermediate reprocessor or the ultimate end user. By way of further example, a steel producer may produce a hot rolled steel coil of certain dimensions which is then purchased by an intermediate entity which further reprocesses that steel product into an end product which is sold to an appliance, machine or car manufacturer. Such intermediate processors require steel products having certain specifications and characteristics, such as thickness of the sheet, width of the sheet and certain material properties which are inherent to the particular steel production method. Moreover, the intermediate processors who buy raw steel product and resell it to another intermediate processor or the ultimate end user will process various different types of steel into various different kinds of end products. Thus, it is important that the intermediate processors have access to a plurality of available suppliers so that they are able to purchase the initial steel product having the desired characteristics. Conversely, producers of steel product also provide numerous different types of raw steel products that are purchased by these various intermediate reprocessors. While such producers and sellers of the raw steel product may produce these steel products on a continuous basis since they may constantly be in demand by the intermediate buyers and reprocessors, certain materials may also be specifically ordered from these sellers upon direct specification by these buyers.

In the metals industry in general, and particularly in the steel industry specifically, such buying and selling of this type of commodity is quite common. Referring to FIG. 1, for example, there is shown therein a simplified flow diagram representative of a typical metals industry supply chain. A number of suppliers, generally referred to as Supplier A, Supplier B and Supplier C, supply the materials necessary to producers in order to manufacture a “raw” metal product. For example, iron ore can be provided to an integrated steel mill to provide steel coils and bars or aluminum ore could be provided to an aluminum producer to manufacture aluminum sheet. By way of example, there are approximately 70 steel producers within the United States which can manufacture raw steel products for reprocessing by intermediate parties for ultimate use as consumer end products. The producer can be represented by an integrated steel mill or a mini-mill processing plant. Generally, these producers provide the steel product to intermediaries within the supply chain, but may also be classified as an intermediate reprocessor for the supply of a finished end product to an end customer.

Typically, within the steel industry there are four levels of intermediary processors. These levels are generally representative of the type of sophistication utilized in reprocessing the steel products into a finished product for use by an end customer. For example, a first level of an intermediary may be a warehouse operation in which no reprocessing of the steel product itself is accomplished, but this intermediary merely warehouses and facilitates the transfer of product from the steel producer to either other intermediaries or the end customer.

A second level intermediary is one which performs basic reprocessing functions to the steel product. For example, a second level intermediary may take a 48 inch steel coil and “slit” that product into two separate intermediate products which may be used by other, or third or fourth level, intermediaries to produce an end product. By way of example, a third level intermediary may need a 12 inch coil product and another intermediary may need a 36 inch steel product whereas the second level intermediary can reprocess the original 48 inch steel product into the separate products required by the separate third level intermediaries. As was stated, a third level intermediary typically provides more advanced reprocessing functions, such as providing either a painted or galvanized steel product, or forming or stamping the product into a still further reprocessed product which can be used by a fourth level intermediary.

The fourth level intermediary can be characterized by a strategic supplier to an ultimate end user. By way of further example, a fourth level intermediary may be a sheet metal reprocessor who takes a steel product and stamps or forms that steel product into a fender or other automobile body part which may be utilized by a car manufacturer in the assembly of an automobile. The fourth level intermediaries are generally manufacturers who supply products to ultimate end customers according to the end customers detailed product specifications. The end customer can either be the automobile manufacturer or other distributor who assembles finished products into a consumer product, or the end customer can be the consumer itself. Thus, it can be seen that intermediaries may buy and sell within different levels of the supply chain. Also, as mentioned above, a steel producer may also perform certain functions that a discrete intermediary may provide as a specialized function in and of itself. Therefore, a buyer at one level may also be a seller at another level.

In conventional transaction methods, a buyer must inquire of each individual seller in order to determine if that particular steel manufacturer can produce the desired product within the needed time constraints and price to be reprocessed by the buyer. Such buyers may have identified specifications in mind for the steel product that they need to purchase, since that specific “raw” steel product is required to produce a particular end product by that intermediary. The buyer/intermediary will typically have a reprocessing time schedule that it needs to fulfill in taking the “raw” steel product from the seller and transforming it into the finished end product, also by a particular schedule date which it must meet in order to resell that product to its customer. This process typically requires the buyer to notify each of its individual sellers that it has dealt with in the past in order to determine if that seller can meet its product specifications and delivery requirements. If not, a new seller must be contacted. Typically, one of the most important factors in this buying decision is the price at which the buyer can purchase that steel product. While the quality of that steel product is important, since numerous sellers are available it is important that the buyer be able to purchase its desired product on time and at its lowest cost so that it can produce an end product within its pricing structure. Special steel formulations or “recipes”, for example, may require that a seller/producer set a higher price so that it can perform the necessary manufacturing processes required to produce that particular product for that particular buyer according to its defined characteristics or specifications. Moreover, logistical problems, such as transportation of that product from the seller to the buyer, may dictate a higher price in that the product must be transported over relatively long distances, either by road, rail or water, to the buyer's location.

In general, four primary factors influence this type of commercial transaction: price; location and logistics (i.e., transportation); steel mill rolling schedule; and product quality. In turn each of these primary factors are influenced by their own separate sub-factors. Thus, as can be seen, there are a variety of considerations that must be accounted for by the buyers and sellers within this marketplace. Therefore, a buyer must have access to numerous forms of information in order to be able to make an informed buying decision from a particular seller. The buyer must accumulate, organize and interpret this vast amount of information in order to be able to make the most cost-effective purchasing decision. Each member of the market supply chain needs to be informed of trends within the industry, such as which particular end users anticipate needs for which particular products, as well as which sellers are able to provide the steel product that it needs in order to perform these tasks. In general, the metals market is demand driven, in that the end product market drives the flow of commerce along the supply chain.

Conversely, sellers at every level need to be aware of the same type of information so that they can be prepared to manufacture or produce through reprocessing those particular steel products that their buyers will need in order to meet their future requirements. Since the majority of steel products are provided according to an established “order book” or catalog comprised of relatively standard steel products (or commodities), sellers need to evaluate industry trends in order to determine which of those products are of particular commercial importance at any given time. Additionally, sellers need to know which particular intermediate industry members or other buyers are able to meet these end user requirements so that it can make informed sales decisions. For example, if a particular buyer in the supply chain is having cash flow problems, the seller needs to be informed of this so that it will know under what terms and conditions it will sell the product to that reprocessor.

In the domestic steel industry above, for example, there are over 65 integrated steel mills and mini mills which may be able to produce a particular steel product which would be of interest to buyers, be they intermediaries and/or end customers, which themselves number in the tens of thousands. Thus, a typical buyer needs to gather and assess information from various sources to make purchasing decisions. What is needed then is a system whereby the interested parties within the metals industry can gather the most relevant and pertinent information the individuals need in order to make informed purchasing decisions.

It would be advantageous, for example, if a buyer were able to eliminate having to investigate certain non-qualifying seller or intermediate processors when trying to make a particular buying decision. By knowing which particular sellers are able to produce the steel product that it will need in its reprocessing plant, the buyer can make more informed buying decisions and also can avoid having to check with certain sellers directly in order to inquire whether or not a particular steel product is available for purchase. Alternatively, it would be advantageous for sellers to be able to have access to much of the same information so that it may identify trends in the industry so that it can position itself to provide the desired steel products to these buyers/reprocessors.

In recent years, the buying and selling of products “on-line” has enabled consumers to tap into vast amounts of information in order to purchase consumer products, such as books, computer equipment, airline tickets or even automobiles via the “world wide web” or the internet. A person having access to the internet via a home computer or PC can access this information by performing a keyword search, for example, to identify the sellers of these types of products, or can directly contact a particular business' website if it is known. This may require searching on the internet for sellers of particular products which again involves the buyer accessing and analyzing a lot of data. In the purchase of books, for example, popular websites such as “amazon.com” and “barnesandnoble.com” are available to consumers in order to purchase any type of book on any subject. However, each of these websites must be individually accessed by that person and then searched in order to determine if a particular book that person wishes to purchase is available from those sellers. Moreover, other booksellers on the internet may be available which would not be known to the purchaser without either searching for those websites or being contacted by that book seller directly. Thus, when a person wants to purchase a particular book, for example, the seller would not know which buyer was interested in a particular book in its inventory. Hence, the buying and selling of products over the internet generally requires that a one-to-one relationship be established by each buyer and seller. And a vast amount of information must be processed even before a particular seller can be contacted and the transaction completed.

It is therefore an object of the present invention to provide a dedicated marketplace wherein buyers and sellers of steel products can have access to the most relevant information desired in order to make timely informed decisions.

It is a further object of the present invention to provide an on-line system in which contracts for the purchase and sale of steel products can be entered into, including all the legal terms and conditions for a particular transaction.

It is a still further object of the present invention to provide means for establishing purchasing credit for the buyers for automatic payment to sellers upon completion of a transaction.

It is yet another object of the present invention to provide a mechanism for the transportation of steel product from sellers to buyers via approved carriers.

### SUMMARY OF THE INVENTION

The above objects are attained by the present invention, according to which, briefly stated, an interactive on-line steel marketplace is provided for buyers and sellers within the steel industry. Buyers and sellers are brought together within a dedicated website whereby buyers may be provided with information from particular sellers including products available and price and delivery requirements, so as to be able to make informed decisions without having to contact individual sellers directly. The steel electronic commerce system of the present invention provides an aggregation of all aspects of doing business, including the purchase and sale of steel products, credit qualification for buyers and logistical planning for the transfer of steel products from the seller to the buyer. During a member registration process, each individual member sets parameters which determine which type member they will be, either a buyer or a seller. In some instances, a buyer may also be qualified as a seller to other buyers of certain specialty steel products.

The present invention is exemplified by a networked community market system providing real-time transactions between a plurality of identified community members over a communications network. The system comprises a controller for communicating with each of the plurality of identified community members over the communications network and contains a database of information articles. Means are provided for identifying each of the community members according to predetermined profile selection criteria, the community members including at least seller members and buyer members. At least one seller computer communicates with the controller and is programmed to provide seller business information from such seller members and is accessible by at least one of the buyer members. Means are provided for displaying the selected seller business information to the buyer members according to the identification means. The seller business information includes at least product information, manufacturing lead time and transportation information, wherein a catalog of seller products are available for review by the buyer members. Acceptance means are operatively connected with the at least one seller computer for accepting an order from one of the buyer members to purchase a product from one of the seller members.

Buyers can purchase steel products from a Seller's unique product guide, via either a fixed price or auction model. Preferably a buyer has previously negotiated special discounts from individual sellers, which discounts are automatically applied upon completion of a transaction. These special pricing mechanism are compiled according to the buyers profile information retained by the seller, and are only available to that particular buyer member, ensuring confidentially of pricing between individual buyers and sellers.

The communications network preferably comprises the internet, or “world wide web” and the controller preferably comprises one or more servers for a marketplace website. The identification means further includes means for the individual community members to establish a personalized user profile.

In a method of effecting sales of products between a plurality of identified community members over a closed communication network, the method providing for real-time authorization of sales comprises the steps of storing information articles in a database and receiving from the community members identification information. The community members are categorized into one of seller members and buyer members according to the received identification information. Product information is received from the seller members and separated into a plurality of product types, the product types then being available for review and purchase by the buyer members according to the received identification information. A purchase message is transmitted from one of the buyer members to one of the seller members for a product, and a purchase transaction is recorded between the buyer member and one of the seller members for the product.

Preferably, the seller members are registered as such within the communications network. The communications network is comprised of a website on the world wide web, and is controlled by one or more servers which stores the information articles database and the individual community members identification information, or member profiles. While the seller members are registered within the website controller, buyer members are prompted to establish their individualized profiles from a set of identification criteria. Preferably, buyer members are registered as authorized buyers by further establishing a credit profile which enables them to review and/or purchase products from the seller members.

Functionality of the electronic commerce site of the present invention provides an auction mechanism where buyers can bid and sellers award purchases according to an auction mechanism. A purchasing card module to the present invention allows for visual confirmation of credit availability of a particular buyer member. For catalog purchases as well the purchasing card program allows for a determination of a buyers members available credit before an order can be placed by that buyer. By way of example, the buyer member has placed a bid on a product and is to be awarded the purchase, the seller member has the ability to check the buyer member credit availability prior to the final award. Should the buyer member have sufficient credit available in their account, a charge to their virtual credit card will occur only after the seller member has awarded the sale to that buyer member. In a situation where the buyer member does not have sufficient credit, the seller member has the option of either awarding the bid to another buyer member or award the sale. It is then the responsibility of that seller member to receive payment from the buyer member separate and apart from the purchasing card program. In a case of catalog buying for example, the buyers credit worthiness is not investigated until the buyer places an order. Additionally, a final order cannot be placed until it is determined that the buyer members credit can cover that particular purchase.

Preferably the buyers final settlement with the seller member is contingent upon three events occurring: the date of shipment of the product, date of goods received by the buyer member and the date of buyer member acceptance of those goods. Preferably the buyers is notified when the goods are shipped. When the buyer member accepts the goods, one of two alternatives can occur based upon the choice made by the participating seller member. Seller members can be giving the option of receiving advanced funds or being paid once the buyer payment has been received by the credit issuer. In either case the seller member is still guaranteed payment. However, in the second alternative, the seller may not receive payment for 90 or 120 days.

In a logistics module of the present invention, after the buyer and seller have agreed to enter into a transaction and preferably after it has been determined that the buyer either has sufficient credit available to enter into the transaction or through previous negotiations between a seller and buyer on payment terms, the buyer through the website controller can make arrangements for the transportation of the steel products purchased from the seller member to the buyer member. The buyer member can either contact directly its own carrier, or the website controller can, once the transaction has been entered into between the buyer and seller, place for bid the transportation of the goods from the seller to the buyer. Certain identified carriers can be provided the opportunity to bid on the transportation of the goods. The buyer need merely only indicate where the goods are to be delivered and the maximum price the buyer is willing to pay for those transportation charges. Once a transportation carrier has provided a price which is below the buyer members upper limit, the transportation carrier can be automatically contracted with in order to deliver the goods to the buyer members. The website controller can thus officially make use a particular carriers load carrying capacity by directing that carrier to retrieve more than one series of items ordered by more than one buyer for example, such as when a seller is to deliver multiple orders to multiple buyers in a given geographic location. Thus, transportation and delivery charges for the buyer members can be minimized.

The steel electronic commerce system of the present invention provides a sophisticated yet easy to use application to permit steel buyers and sellers to dynamically interact by displaying products for sale, placing offers to buy, negotiating legally binding contracts, placing orders and tracking order status. The system provides an integrated electronic framework that supports authentication, security, privacy and transaction processing. In addition, documents and information related to seller members, buyer members, products, pricing, procurement documents, order status, inventory and shipping is preferably stored on multiple databases within the website servers for easy retrieval by authorized members.

### BRIEF DESCRIPTION OF THE DRAWINGS

The present invention will be described and become more readily apparent in considering the detailed description taken in conjunction with the drawings, which are shown by way of example only, wherein:

FIG. 1 is a schematic overview of a buyer registration process of the present invention;

FIG. 2 is a schematic overview of a seller registration and personalization process of the present invention;

FIG. 3 is a simplified flow diagram representative of a buyer purchasing steel according to the present invention.

FIG. 4 is a schematic diagram of a logistics provider registration process according to the present invention; and

FIG. 5 is a schematic flowchart showing the operation of the logistic program of the present invention.

### DETAILED DESCRIPTION OF THE PREFERRED EMBODIMENTS

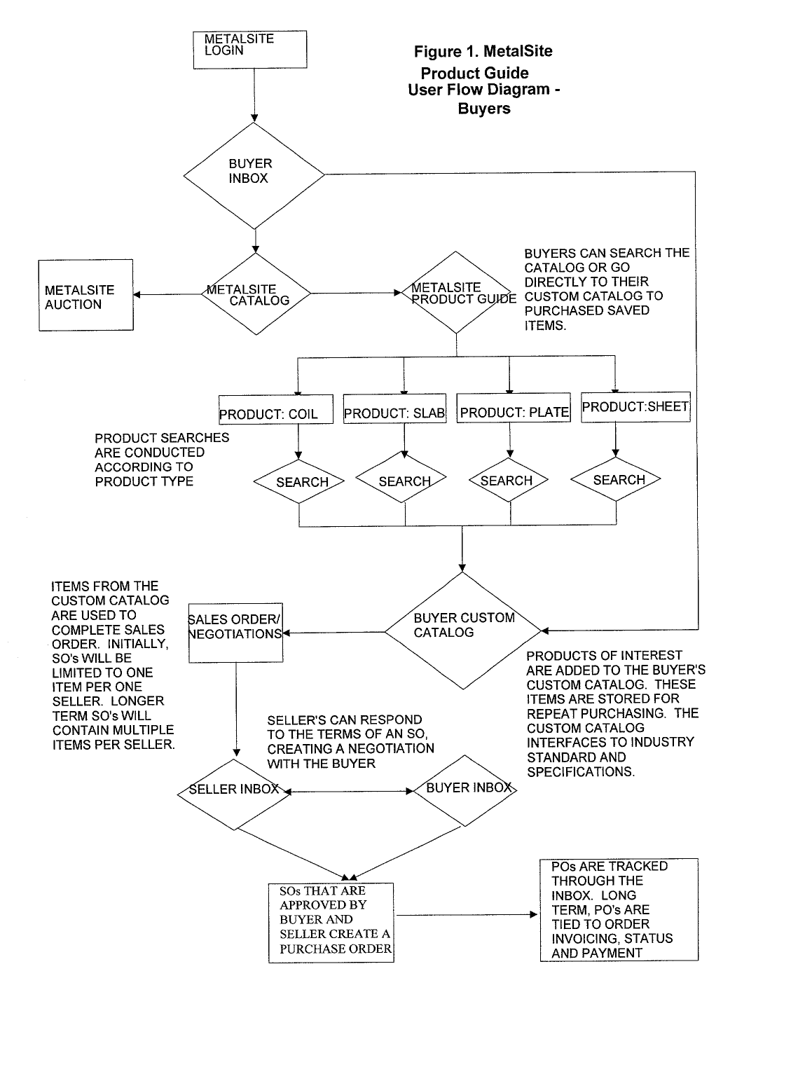

Referring now to the drawings in detail, the over-all structure and operation of the electronic commerce system of the present invention will be described, in which like reference numerals refer to like components. In order to actively engage in electronic commerce according to the present invention, qualified users must either register as a buyer (FIG. 1) or a seller (FIG. 2).

Although the operation of the electronic commerce system of the present invention will be described in particular with respect to the purchase and sale of steel products via the internet, including all the logistics and payment requirements associated therewith, it will be understood by those skilled in the art that the purchase and sale of various types of commodities and other products can be accomplished through the operation of the system of the present invention.

As part of the buyer registration process, a buyer also has the opportunity to apply for and be approved by sellers for an automatic bill payment process. This can take one of two forms: a virtual credit card or automatic electronic bill payment. In the virtual credit card program, the buyers have the opportunity to complete a credit application wherein the buyer completes the profile identifying that buyer and also selects those sellers to which the credit qualifications and information is to be sent. Typically, the sellers are those from which the buyer has previously purchased steel. After the credit application is submitted by the buyer, the website controller reviews the application to determine that it is complete. The applications are then sent on to the identified sellers which will either accept or decline the buyers credit application. Preferable this credit information is saved on the website's controller server computer so that when additional sellers are added to the buyer's profile, the existing credit application can be reviewed by those new sellers without the buyer having to reenter the information, except for those key items of information that may have changed since the time of the buyer registration process.

In the event that a buyer's credit application is disapproved by any or all of the sellers, it does not necessarily prevent that buyer from being registered to purchase product through the site. The seller may still choose to sell to such a buyer in the same way that conventional sales transactions are entered into, in that the seller issues an invoice to the buyer after the on-line transaction has been completed. As in the normal course, upon receipt of payment, or whatever other arrangements are agreed to between a seller and a buyer, the product may be shipped from the seller to the buyer after processing through the electronic commerce system of the present invention.

In a similar manner, a seller is registered to sell products through the electronic commerce system of the present invention, as shown in FIG. 2. The seller provides the necessary profile information, such as indicating the type of steel product that it will sell (e.g., flat rolled, sheet, and coils) as well as from which particular manufacturing location from its products will be shipped. Also, the seller must agree to the terms and conditions established by the operator of the electronic commerce system in order to be qualified to act as a seller through the website. Upon qualification of a new seller, information about those sellers is preferably automatically transmitted to all the approved buyers within the site. Since it is desired that the buyer list be maintained confidential within the site, it is preferred that buyers initiate contact with these new sellers and must agree to transmit their previously saved credit profile information to these new sellers. In much the same manner, should the seller wish to add an inquiring or new buyer to it's approved buyer list, that buyer information is again sent for credit approval to the credit issuer to ensure proper credit availability. In this manner, buyers and sellers cooperate to become purchasers of products through the electronic commerce system of the present invention.

NOTE: Enlarge upon buyer discount process.

Buyer members approved by the website controller, while awaiting approval from seller members, have the ability to view seller member product catalogs and product reports, but cannot yet purchase steel products. When the buyer member is registered with the website controller but not with any of the seller members, who may be categorized as Manufacturers, Dealers, or Resellers, preferably the system will provide the following view of the electronic commerce system of the present invention to that particular buyer member:

Home Page

Requires Digital Signature w/identifying & authorizing certificates.

Website Product Catalog

ASTM Steel Product Specifications

Manufacturer, Dealer, Reseller Catalogs (registered with Website controller)

Registration Form to initiate process of registering with a seller member (Manufacturer, Dealer, Reseller).

Successful completion of the registration process will culminate in generating an Authorizing Certificate for the applicant buyer member

Buyer's Profile (seller's requirements)

Leverage the Buyer's profile w/Website controller

Demonstration

User/Technical Guide

Content

Advertisements

Secured E-mail

Once the buyer member has become registered with one or more seller members, they will then be permitted to view and purchase from seller product catalogs, move product to the staging bin/holding area for later purchase, bid on auction products and review buyer history. Registered buyer members with approval from seller members can also see product reports. When the buyer member is registered with one or more Manufacturers, Dealers or Resellers, the website controller will provide the following view of the electronic commerce system of the present invention:

Home Page

Website controller's Product Catalog

ASTM Product Specification

Seller Member's Product Catalog (Manufacturer, Dealer, Reseller)

Order Management

RFQ, Quote, Standing Order/Contract, Standing Order Release, Purchase Order, Negotiate

Inventory (prime & secondary)

Order Fulfillment, Order Status, Shipment Information

Business Information

Electronic Commerce Asset (secured view)

Seller Member's Product Promotional Offerings

Demonstration

User/Technical Guide

Content

Advertisements

Secured E-mail

After buyer members have become registered by particular seller members, those buyer members will preferably then apply for approval from a financial institution, credit card issuer or access to other line of credit in order to initiate steel purchasing transactions including payment options. In this way, seller members can be assured of prompt payment once a purchase order is confirmed between the seller member and buyer member.

In order to affect the transfer of product from the seller member to the buyer member, the buyer members may also apply for approval from a logistics vendor and may initiate transactions including shipment and delivery, as described more fully hereinafter.

### Sellers

Sellers import product, manually enter product, authorize buyers, award product to bidder of choice, unaward and re-award products and review seller history.

Approve buyers through the Buyer Registration process with credit and industry references

Host Catalog to accept fixed-price orders and bids

Accept transactions for make-to-order product

Manage lead times for delivery

Preferably, after a person or organization has been registered as a seller member, the seller compiles a seller catalog which contains information with respect to the particular products it can produce or, in the case of an intermediary processor, send an internal e-mail (or external) not necessarily to another associate, listing the products available within its inventory and for sale at a particular price. That product information is then available to those buyer members who have been registered or authorized as such and are particularly interested in purchasing those particular products. In order to filter out non-desired product information, the buyer member's profile acts, within the website server, to eliminate those products within a particular seller member's seller catalog which do not reflect that buyer's unique profile. Thus, news and product information is selectively directed to that buyer member when accessing the community such that they are only informed of particular products.

Of particular importance to the electronic commerce members is the opportunity to bring buyers and sellers together in one area, such that the transaction of business or the transfer of information and goods is greatly facilitated. As represented by FIG. 3, the members within the electronic commerce systems are able to conduct business with one another on a real-time basis without having to directly contact each individual member to seek the specific information that they desire. The electronic commerce system of the present invention is designed particularly around supporting a secure, structured steel marketplace where buyer and seller members can protect and build their business relationships. With access to the pertinent information of value to them, the system supports the buying and seller of steel products via various formats, such as by auction, fixed price, private pricing mechanisms between particular buyers and sellers, as well as through buyer members issuing a request for quote (RFQ) to particular sellers to inquire if a particular product can be supplied. The conduct of business within the system is of value in that buyers can specify those particular products in which they are interested, while filtering out that information which would otherwise clutter the decision making process. For example, if a buyer member who is an intermediary processor may be interested only in hot rolled steel products for further processing, as opposed to cold rolled or galvanized steel products, only those types of hot rolled products in which it is interested in purchasing from particular sellers would be placed in that buyer members “buyer history” from which it can review and select products to purchase.

By way of example, if a seller has excess inventory of a particular hot rolled product and that information has been placed within an individual seller's catalog, a notification can be provided to those buyer members interested in that particular product, informing him or her that that product is available. However, if a cold rolled product has been offered for sale, that information is not presented to that buyer member who then is not burdened with having to retrieve or analyze non-pertinent information. In purchasing materials on-line, as will be explained more fully hereinafter, a buyer can coordinate in one area those activities so as to make better, more fully informed purchasing decisions.

As mentioned above with respect to the steel industry supply chain, in this example the seller members are those which produce a “raw” steel product which is of interest to intermediary buyer members who then reprocess that “raw” steel product into a “finished” end product which is then resold to the ultimate end user. As will be appreciated, in this example, the ultimate end user may be an automobile or appliance manufacturer that is interested in purchasing stamped steel products for assembly into an automobile, or may be an upper level intermediary processor that may further process the steel product for sale to a consumer through a retail outlet. Each of these end products are manufactured according to certain specifications which the intermediary reprocessors (or buyer members) must take into consideration when purchasing the steel product from seller members in the supply chain. Because reprocessors have certain specifications which must be met in producing the end product, they must purchase “raw” or intermediate steel products also made according to certain specifications so that the steel product can be reformed and/or reprocessed into the desired end product. Thus, buyer members are interested in purchasing certain grades of steel and it would be advantageous to such a buyer to be able to access only those kinds of products and not have to weed through all types of steel products in order to make the purchasing decision.

It is well known in the steel industry for buyers along the supply chain to be interested in a steel product which can have various characteristics, such as coil size, material chemistry (or “recipe”) and/or thickness, among others. For example, a “raw” steel coil is produced by a hot rolling process, which can then be reprocessed by cold rolling, galvanizing, slitting or stamping, etc. Each of these steel products has certain characteristics which enable them to be used by a particular reprocessor to produce specific end products. While some raw steel products may have wide applicability such that a particular cold rolled product can be used by different intermediary reprocessors to produce the different end product, unless the buyer has provided particular information when establishing its profile, the buyer members must otherwise investigate the various raw steel product types and only select those which meet its specifications.

Also, sellers may produce these steel products having different specifications for widths, thicknesses, gauges, and may be produced at one or more locations. The location of the production facility or steel mill is an important factor in that a buyer must then consider the logistics of transporting that product to its reprocessing facility. For example, transportation must be provided from the seller member's plant to the buyer member's reprocessing or stamping plant. If a particular seller member has a production plant closer to the buyer's facility, it would be more advantageous to purchase the product from that plant to thereby minimize transportation costs. Therefore, because of the numerous factors that must be considered by the buyers and sellers in making informed business decisions, the interactive commercial community of the present invention provides a unique advantage in bringing together and filtering all that information and presenting it to the individual community members within a coherent mechanism.

By way of further explanation, it will be appreciated by those skilled in the steel industry that seller members may also include general plant facilities suppliers, such as steel plant machinery and equipment or even general office supplies. Conversely, buyer members may be office supply purchasers and not necessarily steel product buyers.

Within the steel industry, for both producers and reprocessors, the steel product marketplace presents unique characteristics. Steel can be considered a commodity in that numerous producers are available and can sell their products to numerous buyers anywhere along the supply chain. However, each of the individual products produced by the sellers tend to have unique characteristics, as mentioned above, since such specifications are required to produce a desired “end” product for resale either to more sophisticated intermediary reprocessors or for distribution to the public in the consumer market. For this reason, the price of the product is not necessarily the leading factor in making a purchasing decision. Time for delivery, cost of delivery, logistics in transporting the product from Point A to Point B and other factors will affect the purchasing decision. Moreover, since a reprocessor must also meet a final delivery requirement in order to sell its reprocessed or finished end product to its user, its own manufacturing schedule must be taken into account in deciding when the raw steel product must be purchased to provide the reprocessor sufficient lead time in order to manufacture the desired end product. Hence, the delivery schedule is also an important factor for the buyer to consider.

Whereas a typical buyer may generally buy from a limited number of sellers, in conventional steel product transactions a buyer must still individually contact each of those sellers in order to determine if its requirements can be met. In personalizing its member information or profile, a particular buyer member can not only identify those sellers whose product information it desires to receive, but it can also investigate what type of steel producing capabilities those particular sellers can provide. For example, a particular buyer/reprocessor can efficiently query the particular seller catalogs it has previously identified, using advanced search tools and facilities, as available to produce steel product according to its specifications, and may then inquire of them through the interactive community of the present invention whether those sellers/producers have such a product available at that time. The buyer member can then receive this information from each of those sellers and determine which of those identified sellers can produce the product within the desired time frame. However, in another advantage of the present invention, it is not uncommon that a buyer may have an emergency need for a particular product or a seller may have excess inventory that it needs to quickly dispose of, whereby members of the interactive community of the present invention may make particular use of that specific information.

In addition to the buyer contacting particular sellers and inquiring of them if they can provide their desired product, such as a by submitting a buyer RFQ, buyers and sellers can communicate within the electronic commerce system in order to purchase steel products according to three other mechanisms. These transaction mechanisms are generally referred to as fixed price selling, auction selling and private view pricing.

In addition to the three different transaction mechanisms set forth above, “switches” may be available for authorized buyers to facilitate commercial interaction between buyers and sellers. For example, all buyer members may be granted access to all the product catalogs of a number of seller members without any particular seller member having to individually qualify any particular buyer member. Alternatively, the seller may indicate only those of its “authorized” buyers which have met certain criteria of the seller member, such as a minimum credit worthiness, past purchasing history, or the like. In this manner, while any particular buying member may have access to the products available from any particular seller only those buyers which have been authorized by the seller are able to actually place orders with that seller. As only authorized buyers are able to purchase the products, each of those buyers must be individually authorized by the particular sellers thereby eliminating the need for the seller member to repeatedly re-qualify a buyer member when each product order is enforced. While all buyers may be able to view all the products available within a particular seller catalog, which then enables those members to determine if they want to become qualified buyers, certain information such as pricing or delivery schedules would not be available to non-authorized buyers. Again, this prevents a seller from being contacted by buyers with which the seller has indicated he or she does not wish to transact business.

A third switch is available in which only those identified authorized buyers which have previously been added by a particular seller are authorized to view and purchase products from that identified seller member. Due to the number of individuals who are able to access the internet, it is important that sellers be able to filter out and accept only those authorized buyer members of the interactive community in order to prevent its individual on-line catalog from being over-accessed by the general internet community. This filtering or switch mechanism is advantageous in narrowing down not only from the internet to the interactive community, but also within the community itself to only those buyers and sellers which have expressed a mutual interest in transacting business. For example, a seller can use the content portion of the interactive community to discover information about a particular buyer which may affect its credit-worthiness. In this manner, a seller can then individually contact that particular buyer/reprocessor, and inquire as to its business prospects so as to assess its ability to purchase products it has ordered from that seller. Sellers can use the content available within the community to determine if individual buyer members satisfy the criteria to become “authorized” buyers.

By way of further example, the steel community, there are what is referred to as the “primary” and “secondary” markets. The primary market can be defined as one in which top quality products are available for sale to buyers, either for further reprocessing or final sale to the public The secondary market involves lower quality steel products, such as scrap products, and requires re-melting and separation out of impurities, or steel product which does not meet particular product specifications. In either case, these products can be offered for sale by seller members via fixed pricing, an auction/bid mechanism or private pricing.

NOTE: Discuss product search capabilities; discounts automatically provided; secure transactions; confidential pricing; only buyers sees his/her actual price at end of transaction.

Once the seller member is qualified, the responsible individual can then identify those products, such as hot rolled, cold rolled, coated, or tin mill products and the individual product criteria such gauge, width and height, which it will sell through the website. Alternatively, it can also identify whether the seller member will sell such products either through an auction mechanism or a fixed price mechanism, as more fully described hereinafter. The seller member preferably establishes a suggested price for the sale of such products. That price can be individually negotiated with individual buyer members in an off-line manner, including volume discounts and special buyer member discounts which are separately negotiated between the seller member and the individual buyer members, which are only accessible by that buyer member. In addition to listing the typical products that a seller member intends to sell, the seller member preferably also identifies to the controller of the website who its typical customers are, so that those customers maybe individually contacted to determine if they wish to be identified buyer members through the website.

Certain basic information about the seller member must also be identified, such as location of the seller member, plants where the seller member produces individual products to identify where they will be shipped from, as well as terms for accepting payment, such as maximum time required for payment such as a thirty day invoicing system, and types of payment that the seller member will receive. These types of payments may be through certain identified credit facilities or through direct invoicing to the buyer member, for example.

By setting up its product categories the seller member is establishing its own unique catalog, which includes products to be sold in an auction or through a fixed price product guide. In the typical auction mechanism, the seller identifies certain products which will be sold to the registered buyer members, typically the highest bidder or that which the seller member identifies can provide the highest value to the seller in establishing price and delivery terms. For example the seller may establish a reserve price below which it will not sell the product through the auction mechanism, and bidding buyer members must meet this minimum price before the seller will sell the product. Buyer members are then given an opportunity to bid on the products by entering a purchase price, either above the minimum reserve price or above the next highest bid that has already been bid by another buyer member, and must then monitor activity on the site to determine if its bid is the highest and/or winning bid. Buyer members can be individually notified through the website controller whether their bid has been successful or if another buyer member has outbid them for that product, thus giving the buyer members the opportunity to increase their price and outbid one another for a particular product.

The seller members are also able to establish their product guide where they can establish the types of products that they will sell, the suggested price at which those products will be sold over the internet, as well as the delivery terms. The seller member can identify both prime and non-prime products to be sold to interested buyers, as is now is commonly done through the tedious and time consuming individual negotiated basis through particular buyers and sellers. As each individual seller member identifies those products that it will sell through the internet site, the website controller compiles a product guide which identifies all the individual types of steel products sold through the site, as well as those seller members which offer such products. Thus, qualified buyer members can view a variety of products sold by individual seller members which meet its certain search criteria, as more fully described hereinafter.

When sellers have been identified and qualified to be seller members on the website, the individual buyers with which they have previously done business in the past can be contacted so as to become qualified buyer members on the site. Once a potential buyer has been identified and qualified as a buyer member, the particular specific terms and conditions which will apply between that particular buyer member and a seller member are negotiated separately between that buyer and seller. For example, a particular buyer may be entitled to volume discounts from an individual seller member as well as special discounts on certain products which can be independently negotiated between buyers and sellers. Thus, for example, when that particular buyer member purchases products on-line from that seller member, it will do so based not only on the posted suggested price that the seller is offering the products, but also with the knowledge in mind that it is entitled to those specific discounts. Thus, when a buyer member purchases a product, that buyer member only will see what the final sale price of that product is. The website controller can automatically determine what the final sale price for any particular order will be for that buyer member and display that price when the transaction is completed by the buyer member. In the secure transaction offered by the electronic community website, only the qualified buyers will see the prices that have been separately negotiated.

In order for a buyer to purchase products from sellers on the electronic commerce website, the methodology shown in FIG. 3 can be implemented. After the buyer member has logged into the site, an authorized individual can begin searching for the particular product needed according to the form, dimensions, chemical criteria, etc. that are typically used when a buyer purchases steel products. A search screen is presented to the buyer member so that the individual characteristics that it needs can be entered or “clicked” and the website controller will display to the buyer member the seller member that offer such products, as well as the retail price that that product is being offered. The buyer member, if multiple sellers are listed, can then decide which of the products it wishes to purchase and also designate, by clicking in the appropriate area, which products it wants to purchasing and those products are then listed in a holding area. After the buyer has made all its purchased decisions, all the products that have been identified are listed in the holding area along with a final total sale price. That final sales price will automatically include all the discounts available to that buyer member. Preferably, buyers can only initiate contracts with the same seller in any transaction, simplifying the purchase process as well as helping to identify volume discounts that the buyer may be entitled to from that seller. Within the holding area, the buyer can either confirm a purchase of a particular product from that seller, or delete products form the holding area. Once the buyer has made the final determination as to which products it wants to buy, it initiates the electronic sale and the seller member is automatically notified of the buyer member's intentions. If additional terms and conditions need to be negotiated between the buyer and seller, those terms can be identified to the buyer such that when contacted by the seller after the invoice has been electronically generated by the website controller, those individual terms can be finally negotiated in order for the buyer and seller to enter into a final legally binding contract.

As was stated previously, the website allows the electronic commerce system of the present invention for selling steel to give the buyer members the ability to buy either from an auction mechanism or from a catalog with listed prices. For example, the product listed in the product guide can be prime and made to order steel products. The product guide of the present invention gives buyer member the flexible methods of searching a database of steel products and standards offered by many individual seller members, and gives those individual buyer members a fast and easy method for creating and submitting a purchase order (p.o.) for products of their choice. The product guide allow buyers members to purchase prime and made to order steel products through the electronic commerce website using two commerce models. The first is the seller defined catalog model in which buyer members search through listings of products stored in the web-server database. These buyer members create and submit sales orders (S.O.) for these products, and track the fulfillment of these S.O.'s through the website. Seller members can see S.O.'s submitted by buyers members and approve them, reject them or respond to buyers with additional terms and conditions. In this manner, the purchasing process supports a base-line level of communication between buyer members and seller members, reflecting the needs of each party and the requirements of the products (delivery dates, specific product requirements, availability, etc.).

The other commerce model is the made-to-order model allowing buyer members to create and submit orders to steel producers or seller members based upon industry standards specification. These orders becomes a request for quote (“RFQ”), documents that maybe submitted to one, many or all participating electronic commerce steel producer seller members. The seller members have the ability to respond to any RFQ's they receive through on-line negotiations with the buyer member that submitted the RFQ. Once a buyer member and seller member agree to the terms of an RFQ, the RFQ becomes a sales order and a purchase order from the buyer member to the seller member.

As a buyer member selects products from previous purchases and searches on the website, they preferably are added to a buyer member custom catalog. This custom catalog is then stored in the website controller for each buyer member. Buyer members may add or delete items from their custom catalogs at anytime. The custom catalog for each buyer member makes it easier for buyer members to enter the electronic commerce system and order particular products which it needs on a constant basis.

Once a buyer member has selected items to purchase from a particular seller member, the website controller assigns it a unique tracking number. Buyer members may also assign their own tracking numbers to a sales order. Seller members may respond to a comment section of a sales order to thereby create a threaded negotiation. The negotiation can be tracked by each party through the website controller inbox. Once the individual seller member and buyer member approve the final terms of a sales order, it is converted into a purchase order. The status of all pending purchase orders can then be tracked through the buyer member's custom catalog. Preferably once the buyer selects an item and it is added to the custom catalog, a sales order may be created containing certain information such as product information, seller information, such as the address that it is to be shipped from and buyer information such as the address to which the product is to be shipped. Preferably the custom catalog is composed of the following elements: items that a buyer member has added to the catalog sorted by individual seller members; industry standard specifications for steel products that a buyer has added to the catalog; saved sales order template used for repeat orders; and access to saved sales orders not yet submitted to a particular seller member.

The methodology for processing items in a buyer catalog are shown in FIG. 11.

Once an individual buyer member and seller member have agreed on the terms and conditions on the sale of a particular steel product, the website controller may preferably initiate a logistics program in order to implement the transfer of the product from the seller to the buyer. The website controller can provide logistic services in order to ship the products such as by providing a rate quotation, order tracking, load consolidation, and carrier payment. The website controller can either provide these logistic services directly or by serving as an intermediary with a third party who will be automatically contracted to ship products from a particular seller member to a buyer member. By providing this service, “one stop shopping” is provided for qualified buyers and sellers without having to additionally contract with another party to actually ship the product to the buyers location. Terms and conditions can be provided as well for the carrier, including whether the product is to be shipped directly to the buyer or to another party if that buyer acts as a service center for other steel processors. In one embodiment of the logistic program of the present invention, after the buyer member has selected products from a seller member the buyer member can then arrange transportation through qualified carriers or shippers which are registered with the website controller. The website controller notifies the qualified shippers and ask them to bid on their service charges for shipping the product from the designated seller member site to the designated buyer member site. The buyer member can also designate a maximum price that it is willing to pay for the shipment of those products. The interested carriers can then bid on providing this service and the website controller can automatically award the shipment contract to that carrier which satisfies the buyer shipping criteria. The buyer member will then receive a notice from the website controller that the product is being shipped by the winning bidder logistic service provider. If no interested carrier has been identified that meets the buyer members criteria, the buyer can be notified of such and then has the option to either contact the carrier submitting the lowest bid or can arrange product transportation on their own.

As shown in FIG. 3, a process for a buyer to purchase steel through the electronic commerce system of the present invention is shown therein. After accessing the website, in this instance in the preferred embodiment the Metal Site website, the buyer logs in using his or her unique user name and password created upon registration. That buyer is then directed to their unique inbox, where information such as news and new product offerings are automatically directed to the buyer based on their profile. In order to purchase steel products, the buyer enters the Metal Site catalog area of the electronic commerce system. At that point the buyer can select to purchase steel through one or two options: the auction program or the product guide. The auction process is previously described above. In the product guide section, buyers can search the catalog or go directly to their custom catalog to purchase items which have been saved in that catalog either from previous purchases or by identifying those types of products in their buyer profile. As shown in FIG. 3 there are four examples of different product types: coil, slab, plate and sheet. Buyers can conduct product searches according to these and other product types. Products of interest are then added to the buyer custom catalog and these items are stored for repeat purchasing. The buyer custom catalog also interfaces to industry standards specifications. The buyer selects those products which it wishes to purchase from the catalog and become subject of sales orders. Sales orders can be limited to either one item from one seller or multiple items per seller. The items are preferably limited by seller such that the buyer discount, as described more fully hereinafter, is automatically applied based on either volume, selling to a particular buyer or by certain products which have been negotiated as discounted prices to that buyer. Upon completion of the sales order a notification is provided in the seller's inbox for them to respond to the terms of the sales order thus creating a negotiation with the buyer. Negotiation between buyer and seller are conducted through their respective inboxes and a final sales order is approved by the buyer and seller to create a purchase order. Purchase orders are tracked to the respective boxes. The final sale of the product through the purchase order is tracked through order tracking, issuing and payment. As set forth above, payment can be made through automatic debit of the buyer's credit card or by other terms negotiated between the buyer and seller.

Upon completion of the purchase between buyer and seller, transportation for the product from the particular seller location to the buyer's location must be undertaken. Preferably this is accomplished through the logistics program of the present invention as set forth in FIG. 4. In order to be an approved logistics provider, a member of the electronic commerce system must complete a registration process similar to the buyer and seller process. The third party logistics supplier completes and submits the registration form to the website controller which reviews all the forms for completeness and accuracy. The form is checked for the appropriate information and if any additional information or corrections are required, the third party logistics provider is prompted to resubmit the applications form. Upon completion of the registration form, the logistic module of the website controller checks for the providers references, financial information, Department of Motor Vehicle information, insurance and the like. If necessary, a site visit is conducted at the logistic supplier location for the evaluation of routing technology and processes. The contract can then be negotiated between the website controller and the logistic provider. In the event additional information is needed, again the third party logistic provider is prompted to submit that information. This party can then be accepted or rejected according to the website controller's criteria. If accepted the third party logistic provider received an acceptance notice and is now listed as a logistic supplier for the electronic commerce system of the present invention.

Upon completion of a steel purchasing transaction, in which the buyer either receives a notice that they are the successful bidder of the auction or that the seller has accepted their sales order, the seller awards and negotiates the purchase order with that buyer. The buyer can then create an on-line purchase order including purchase order number and the address to which the products are to be shipped. The buyer can either then use the logistic program (FIG. 5) of the present invention or can separately arrange transportation. Upon agreeing to use the logistic program, a notice is automatically sent to the third party logistic supplier and receives the load information, such as product, quantity, type and where the product is to be shipped from as well as to where it is to be delivered.

Upon receipt of notification that a purchase transaction has been completed between a buyer and seller, a quote is received from the carrier regarding the cost for shipping the product from the seller to the buyer. Upon receipt of the best quote for shipment of the product, which can either be based on lowest price or fastest delivery time, or other factors, the preferred supplier is awarded the contract for shipping the product to the buyer. The third party logistic providers then books the shipment and sends a notification of load acceptance and shipping details to the website controller and the seller. The third party logistic provider then contacts with the seller to schedule when to retrieve the load from the seller's location and the seller schedules when that order is to be available at the designated time for pick up by the logistic provider. The logistic provider provides tracking information for the benefit of buyers so that they can be kept up to date as to when the shipment is to be delivered to the buyer, and in the event of any shipment delays which may occur. In this way, the buyer tracks the shipment of the product to its preferred location.

In order to register as a qualified transportation carrier a logistic services provider can register on the site according to the steps set forth in FIG. 14.

In order to expedite the purchase of steel products on the internet the website controller can also provide automatic payment services to facilitate the transaction between seller members and buyer members. The electronic commerce system of the present invention provides an efficient means of handling the online payment and settlement of account process. Preferably this also includes electronic bill presentment and payment (EBT). Moreover, in order to insure prompt payment of accounts from buyers to sellers, the present invention also provides a banking program for the direct payment of invoices. In a preferred embodiment of the present invention, the banking program is divided into two phases:

Phase one includes the development and implementation of a purchasing card program in EBT capabilities.

A second phase of the present invention preferably includes offering polled securitization of accounts receivable, and online replacement for tradition letters of credit, and claims processing. By way of example, the purchasing card program acts a virtual credit card. It provides a mechanism for speeding cash receipts to seller members and provides a reduction in administrative costs of credit accounting and account settlement. For the buyer members the purchasing card program operates to make the credit transaction less burdensome for the buyer by offering a single, one-time credit application for qualifying purchases from all of the identified seller members, thereby providing access to a broader seller base and provides a vendor invoice in a single statement.

In the past, many international business transactions have required letters of credit to facilitate the exchange of goods between overseas buyers. This process can be cumbersome, paper intensive and not well suited to the rapid real time development of web-based business transactions such as the steel electronic market place of the present invention. An organization known as Trade Card provides a web based placement service for letters of credit and provides an interrogative for guarantee of payment, selection of cost efficient transportation alternatives and settlement of all fees deriving from the transaction.

In addition the payment and settlement module of the present invention can also provide a claims processing program designed to save the time, expense and aggravation of a typical nontransit damage or defect claim made by a buyer member. By use of binding arbitration agreements in the network of independent claims inspector and adjudicators, the website controller establishes an electronic evidence collection vehicle to store all documentation's such as photographs and written reports, necessary for claim settlement.

While specific embodiments of practicing the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting to the scope of the invention which is to be given the full breadth of the following claims, and any and all embodiments thereof.

1. A networked community market system providing real-time transactions between a plurality of identified community members over a communications network, said community market system comprising:
a controller for communicating with each of said plurality of identified community members over the communications network;
means for identifying each of said community members according to a predetermined profile selection criteria, said community members including seller members and buyer members;
at least one seller computer operatively connected with said controller, said seller computer being programmed to provide seller business information from at least one of said seller members and accessible by at least one of said buyer members;
at least one buyer computer operatively connected with said controller, said buyer computer being programmed to access seller business information from at least one of said seller members according to predetermined buyer profile information;
means for displaying selected seller business information to said buyer members according to said predetermined buyer profile information; and
acceptance means operatively connected with said at least one seller computer for accepting an order from one of said buyer members to purchase a product from one of said seller members.

2. The networked community market system as set forth in claim 1, wherein the seller business information comprises at least one of seller product information, seller location information and seller financial information.

3. The networked community market system as set forth in claim 2, wherein said means for displaying selected seller business information comprises means for displaying the seller product information, including one or more of product quality, product grade, product dimensions, product price and product delivery information.

4. The networked community market system as set forth in claim 2, wherein said seller product information comprises a seller product catalog.

5. The networked community market system as set forth in claim 1, wherein the metals industry is a steel industry and the networked community market system provides real-time transfer of information and products among individual community members of the steel industry according to said identification means.

6. The networked community market system as set forth in claim 1, wherein the networked community market system comprises a site on the world wide web and the controller comprises at least one server computer, said information article database and said received identification information being stored on said at least one server computer.

7. The networked community market system as set forth in claim 6, wherein said predetermined profile selection criteria comprises at least one of a member name, a member password.

8. The networked community market system as set forth in claim 4, wherein the seller product catalog comprises one or more categories of product type, product quality, product grade, product dimension and product manufacturing location.

9. The networked community market system as set forth in claim 8, wherein the seller product catalog includes a product pricing category further comprised of a fixed price catalog and an auction catalog.

10. The networked community market system as set forth in claim 8, wherein said one or more categories of product type, product quality, product grade, product dimension and product manufacturing location are selectively displayed to said buyer members according to said identification means.

11. The networked community market system as set forth in claim 10, wherein said identification means further comprises means for categorizing said buyer members into authorized buyer members and non-authorized buyer members such that the seller product catalog is selectively displayed only to said authorized buyer members. NOTE: re-work for buyers only seeing product information from certain sellers.

12. A method of effecting sales of identified products between a plurality of identified community members over a closed communication network, said method providing for real-time authorization of sales and comprising the steps of:
receiving from said community members individualized profile information;
categorizing said community members into one of seller members or buyer members according to the received profile information;
receiving product information from said seller members, said product information being separated into a plurality of product types;
selectively distributing to said buyer members one or more of said plurality of product types according to the received profile information;
transmitting a purchase message from one of said buyer members to one of said seller members for a product;
recording a purchase transaction between said one of said buyer members and said one of said seller members for the product; and

13. The method of claim 12, wherein the stages of recording a purchase transaction further includes the step of providing a discount to the said buyer member according to said buyer member profile information.
